(19) United States
(12) Patent Application Publication
(10) Pub. No.: US 2013/0096248 A1
(43) Pub. Date: Apr. 18, 2013

(54) TIRE TREAD FOR HIGH PERFORMANCE TIRES

(71) Applicants: William Marshall Thompson, Simpsonville, SC (US); Xavier Saintigny, Greenville, SC (US)

(72) Inventors: William Marshall Thompson, Simpsonville, SC (US); Xavier Saintigny, Greenville, SC (US)

(73) Assignees: Michelin Recherche et Technique S.A., Granges-Paccot (CH); Compagnie Generale des Establissements Michelin, Clermont-Ferrand (FR)

(21) Appl. No.: 13/807,397

(22) PCT Filed: Jun. 28, 2011
(86) PCT No.: PCT/US11/42146

§ 371 Date: Dec. 28, 2012

Related U.S. Application Data
(60) Provisional application No. 61/359,976, filed on Jun. 30, 2010.

(51) Int. Cl. C08L 9/06

(52) U.S. Cl. CPC C08L 9/06
USPC 524/526

(57) ABSTRACT

Tires having treads constructed of a material that is based upon a cross-linkable rubber composition, the rubber composition in some embodiments including between 25 phr and 5.0 phr of a butadiene rubber and between 50 phr and 75 phr of a styrene-butadiene rubber (SBR). wherein the butadiene portion of the SBR has at least 50% vinyl content. The rubber composition may further include between 25 phr and 60 phr of a plasticizing resin having a glass transition temperature Tg of between 30° C. and 120° C. and between 25 phr 60 phr of a vegetable oil. The ratio of the vegetable oil phr to the high Tg resin phr may, in some embodiments, be between 0.75 and 3. Further, such rubber compositions may also be reinforced with between 100 phr and 200 phr of a silica filler.

### BACKGROUND OF THE INVENTION

1. Field of the Invention

This invention relates generally to tire treads and more particularly, to tire treads for high performance tires.

2. Description of the Related Art

Tires that are suitable for high-powered vehicles or those that are intended for applications involving high operating speeds and/or extreme driving conditions, should give the consumer a feel of maximum control, grip and handling capability. For example, in sports cars and other vehicles that are driven at higher speeds, a tire should provide steering stability, grip performance and structural durability at high speeds. Such tires, which are commonly referred to as “HP” or “UHP” (“High Performance” or “Ultra High Performance”) tires, are rated as being in the speed classes “V” or “Z.” V class tires provide for maximum speeds of between 210 Km/h and 240 Km/h and Z class tires for speeds higher than 240 Km/h.

Different vehicle tires are known for their handling and traction performance under one or more of the following: dry road conditions, wet road conditions, and bad weather conditions, such as on snow and ice. Certain vehicle tires are designed to maximize their performance under wet conditions and other tires are designed to improve their performance in bad weather conditions, i.e., conditions that are not normally encountered in summer driving. It would be advantageous to have high performance tires that performed well in all of these different road conditions without sacrificing other physical attributes.

A vehicle tire is made up of a number of parts or components, each of which has a specific function to perform in the tire. Typically a tire includes a pair of beads in the form of hoops for anchoring the ply and for providing a means for locking the tire onto the wheel assembly. The ply, extending from bead to bead, is comprised of cords that serve as the primary reinforcing material in the tire casing. The tire further includes belts extending circumferentially around the tire under the tread for stiffening the casing and the tread. The tread is located on the outer circumference of the tire above the belts and is that portion of the tire that contacts the road or other driving surface. The sidewall of the tire protects the ply or plies from road hazards and ozone and is typically the outermost rubber component of the tire extending between the tread and the bead.

### SUMMARY OF THE INVENTION

Embodiments of the present invention include tires, and especially tires for high-powered vehicles or those that are intended for applications involving high operating speeds and/or extreme driving conditions, having treads constructed of a material that is based upon a cross-linkable rubber composition. Particular embodiments of the cross-linkable rubber composition include, per hundred parts by weight of rubber (phr), between 25 phr and 50 phr of a butadiene rubber and between 50 phr and 75 phr of a styrene-butadiene rubber (SBR), wherein the butadiene portion of the SBR has at least 50% vinyl content.

Particular embodiments of the rubber composition may further include between 25 phr and 60 phr of a plasticizing resin having a glass transition temperature Tg of between 30° C. and 120° C. and between 25 phr 60 phr of a vegetable oil. The ratio of the vegetable oil phr to the high Tg resin phr may, in some embodiments, be between 0.75 and 3. Further, such rubber compositions may also be reinforced with between 100 phr and 200 phr of a silica filler.

The foregoing and other objects, features and advantages of the invention will be apparent from the following more detailed descriptions of particular embodiments of the invention.

### DETAILED DESCRIPTION OF PARTICULAR EMBODIMENTS

Embodiments of the present invention include rubber compositions and articles made from these rubber compositions, including tires, tire treads and especially treads for high performance tires. Such high performance tires are suitable for high-powered automobiles that are designed for high operating speeds and/or extreme driving conditions.

The rubber compositions include a butadiene rubber, a styrene-butadiene rubber and a plasticizing system that includes a resin having a high glass transition temperature (Tg) and vegetable oil. Surprisingly, these rubber compositions that include the plasticizing system and that are used in the manufacture of high performance tire treads provide tires having a marked increase in wet and dry grip properties without a significant loss in their snow grip and rolling resistance properties.

It should be noted that the rubber articles, including tire components, discussed herein are made from a material that is “based upon” a cross-linkable rubber composition that includes a vegetable oil, a high Tg resin and specific highly unsaturated rubber compounds. The term “based upon” as used herein recognizes that the tire components or other rubber articles are made of vulcanized or cured rubber compositions that were, at the time of their assembly, uncured. The cured rubber composition is therefore “based upon” the uncured rubber composition. In other words, the cross-linked rubber composition is based upon the cross-linkable rubber composition.

The rubber elastomers that are utilized in particular embodiments of the present invention include styrene-butadiene rubber (SBR) and polybutadiene rubber (BR). The SBR used in embodiments of the present invention may be characterized as having a high vinyl content, i.e., the butadiene portion of the SBR having a vinyl content of greater than 50% or alternatively, between 50% and 75% or between 55% and 65%. The high-vinyl content SBR may further be characterized as having a glass transition temperature (Tg) of between −50° C. and −15° C. or alternatively between −50° C. and −20° C. or between −35° C. and −20° C. as determined by differential scanning calorimetry (DSC) according to ASTM E1356. The styrene content may be between 20% and 40% by weight or alternatively between 20% and 30% by weight.

The styrene-butadiene rubber is included in particular embodiments of the present invention in an amount of between 50 phr and 75 phr. Alternatively, the SBR may be present in an amount of between 50 phr and 70 phr, between 55 phr and 70 phr or between 60 phr and 70 phr.

The polybutadiene rubber included in embodiments of the present invention is present in an amount of between 25 phr and 50 phr. Alternatively, the polybutadiene content of the rubber composition may be between 30 and 50 phr, 30 and 45 phr or 30 and 40 phr. The polybutadiene may be characterized as having at least 90 wt. % cis 1,4-content and having a Tg of less than −100° C. or alternatively, between −108° C. and −103° C. as determined by differential scanning calorimetry (DSC) according to ASTM E1356.

Other embodiments may optionally include some quantity of other highly unsaturated diene rubber compositions other than the styrene-butadiene and the polybutadiene already mentioned. There are some embodiments that contain no other rubber components at all other than the SBR and the BR. It should be noted that essentially saturated diene rubbers are not included in the embodiments of the present invention and are, in fact, excluded. In some embodiments of the present invention, the rubber compositions include no essentially unsaturated diene elastomers that are not highly unsaturated.

To further explain, in general, diene elastomers or rubber are those elastomers resulting at least in part (i.e., a homopolymer or a copolymer) from diene monomers (monomers bearing two double carbon-carbon bonds, whether conjugated or not). Essentially unsaturated diene elastomers are understood to mean those diene elastomers that result at least in part from conjugated diene monomers, having a content of members or units of diene origin (conjugated dienes) that are greater than 15 mol. %.

Thus, for example, diene elastomers such as butyl rubbers, nitrile rubbers or copolymers of dienes and of alpha-olefins of the ethylene-propylene diene terpolymer (EPDM) type or the ethylene-vinyl acetate copolymer type do not fall within the preceding definition, and may in particular be described as “essentially saturated” diene elastomers (low or very low content of units of diene origin, i.e., less than 15 mol. %).

Within the category of essentially unsaturated diene elastomers are the highly unsaturated diene elastomers, which are understood to mean in particular diene elastomers having a content of units of diene origin (conjugated dienes) that is greater than 50 mol. %. Examples of highly unsaturated elastomers include polybutadienes (BR), polyisoprenes (IR), natural rubber (NR), butadiene copolymers, isoprene copolymers and mixtures of these elastomers. The polyisoprenes include, for example, synthetic cis-1,4 polyisoprene, which may be characterized as possessing cis-1,4 bonds of more than 90 mol. % or alternatively, of more than 98 mol. %.

Other examples of highly unsaturated dienes include styrene-butadiene copolymers (SBR), butadiene-isoprene copolymers (BIR), isoprene-styrene copolymers (SIR) and isoprene-butadiene-styrene copolymers (SBIR) and mixtures thereof.

As noted above, particular embodiments of the present invention may optionally include other highly unsaturated diene elastomers. For example, particular embodiments may further include no more than 25 phr natural rubber, a synthetic polyisoprene rubber or combinations thereof. Alternatively, the amount of such elastomers may range between 1 and 25 phr, 5 and 20 phr, 5 and 10 phr or 1 and 5 phr.

Other embodiments may include no more than 25 phr of one or more additional (in addition to the SBR and BR) highly unsaturated diene elastomers, including natural rubber and synthetic polyisoprene rubber, either singly or in combination with other highly unsaturated diene elastomers. Alternatively, the amount of such elastomers may range between 1 and 25 phr, 5 and 20 phr, 5 and 10 phr or 1 and 5 phr.

It should be noted that any of the highly unsaturated elastomers may be utilized in particular embodiments as a functionalized elastomer. These elastomers can be functionalized by reacting them with suitable functionalizing agents prior to or in lieu of terminating the elastomer. Exemplary functionalizing agents include, but are not limited to, metal halides, metalloid halides, alkoxysilanes, imine-containing compounds, esters, ester-carboxylate metal complexes, alkyl ester carboxylate metal complexes, aldehydes or ketones, amides, isocyanates, isothiocyanates, imines, and epoxides. These types of functionalized elastomers are known to those of ordinary skill in the art. While particular embodiments may include one or more of these functionalized elastomers, other embodiments may include one or more of these functionalized elastomers mixed with one or more of the non-functionalized highly unsaturated elastomers.

In particular embodiments, a silanol end-functionalized elastomer is utilized in the rubber composition. A silanol end-functionalized SBR having a high vinyl content may be used, for example, as the high-vinyl SBR elastomer in the rubber compositions disclosed herein. Examples of such materials and their methods of making may be found in U.S. Pat. No. 6,013,718, issued Jan. 11, 2000, which is hereby fully incorporated by reference.

In addition to the elastomers, particular embodiments of the rubber compositions useful in the present invention include the plasticizing system having a high Tg resin and a vegetable oil. In particular embodiments, the ratio of the vegetable oil phr to the high Tg resin phr contained in the plasticizing system is between 0.75 and 3 or alternatively, between 1 and 2.5, between 1.1 and 3 or between 1.1 and 2.5.

More particularly, embodiments of the rubber compositions useful in the present invention include a high Tg plasticizing resin which is, as known to one having ordinary skill in the art, a compound that is solid at ambient temperature, e.g., about 25° C., and is miscible in the rubber composition at the level used, typically over 5 parts per hundred parts of rubber by weight (phr) so that it acts as a true diluting agent. Thus, a plasticizing resin should not be confused with a “tackifying” resin, which is generally used at a lower level, e.g., typically less than 5 phr, and is typically immiscible and thus intended to migrate to the surface to give tack to the rubber composition.

Plasticizing resins have been widely described in the patent literature and also, for example, in the work entitled “Hydrocarbon Resins” by R. Mildenberg, M. Zander and G. Collin (New York, VCH, 1997, ISBN 3-527-28617-9). In particular, chapter 5 of this work is devoted to the applications for plasticizing resins, including their applications in the tire rubber field (5.5. “Rubber Tires and Mechanical Goods”).

Plasticizing resins are, in particular embodiments, exclusively hydrocarbon resins, comprised only of carbon and hydrogen atoms, and may be of the aliphatic type, aromatic type or aliphatic/aromatic type depending on the monomers (aliphatic or aromatic) that make up the resins. The resins may be naturally occurring or they be may be synthetic; those that are petroleum-based may be called petroleum resins. In some embodiments, other types of resins may be used, such as, for example, terpene phenolic resins that are available, e.g., from Arizona Chemical Company.

Particular embodiments of the present invention include plasticizing resins that may be characterized as having at least one, but preferably all, of the following physical properties: a Tg greater than 30° C., a number average molecular weight (Mn) of between 400 and 2000 g/mol, and a polydispersity index (PI) of less than 3, wherein PI=Mw/Mn and Mw is the weight-average molecular weight of the resin. Alternatively, the resin may include at least one or preferably all of the following characteristics: a Tg greater than 40° C., a number average molecular weight (Mn) of between 500 and 1500 g/mol, and a polydispersity index (PI) of less than 2. Therefore, in particular embodiments, the Tg may range between 30° C. and 120° C. or alternatively between 40° C. and 100° C. or between 45° C. and 85° C. In particular embodiments, the resin may have a Tg between 0° C. and 120° C.

The glass transition temperature Tg is measured by DSC (Differential Scanning Calorimetry) according to Standard ASTM D3418 (1999). The macrostructure (Mw, Mn and PI) of the hydrocarbon resin may be determined by size exclusion chromatography (SEC): solvent tetrahydrofuran; temperature 35° C.; concentration 1 g/l; flow rate 1 ml/min; solution filtered through a filter with a porosity of 0.45 μm before injection; Moore calibration with polystyrene standards; set of 3 “Waters” columns in series (“Styragel” HR4E, HR1 and HR0.5); detection by differential refractometer (“Waters 2410”) and its associated operating software (“Waters Empower”).

Examples of suitable plasticizing resins for use in the present invention include cyclopentadiene (abbreviated to CPD) or dicyclopentadiene (abbreviated to DCPD) homopolymer or copolymer resins, terpene homopolymer or copolymer resins and C₅ fraction homopolymer or copolymer resins. Such resins may be used, for example, singly or in combination.

Suitable plasticizing resins are readily available and well known by those having ordinary skill in the art. For example, polylimonene resins are available from DRT under the name DERCOLYTE L120, which has a Mn of 625 g/mol, an Mw of 1010 g/mol, a PI of 1.6 and a Tg of 72° C., or from Arizona Chemical Company under the name SYLVAGUM TR7125C, which has a Mn of 630 g/mol, an Mw of 950 g/mol, a PI of 1.5 and a Tg of 70° C. Rosin ester resins are also available from Arizona Chemical such as SYLVATAC RE 40, having a Tg of about 0° C.

C₅ fraction/vinylaromatic resins, in particular C₅ fraction/styrene or C₅ fraction/C₉ fraction copolymer resins are available from Neville Chemical Company under the names Super Nevtac 78, Super Nevtac 85 or Super Nevtac 99, from Goodyear Chemicals under the name Wingtack Extra, from Kolon under the names Hikorez T1095 and “Hikorez T1100”, or from Exxon under the names Escorez 2101, Excorez 1102 and ECR 373.

Particular embodiments of the present invention include an amount of plasticizing resin of between 25 phr and 60 phr. Below the minimum indicated, the targeted technical effect may prove to be inadequate while, above 60 phr, the tackiness of the compositions in the raw state, with regard to the mixing devices, can in some cases become totally unacceptable from the industrial viewpoint. Alternatively, particular embodiments include between 25 phr and 50 phr, between 25 and 40 phr, between 25 phr and 30 phr or between 30 phr and 40 phr or between 30 phr and 50 phr of the plasticizing resin.

In addition to the high Tg resin, the plasticizing system useful in particular embodiments of the present invention also includes vegetable oil that is made up in large part of fatty acids having 16 or 18 carbon atoms. These fatty acids may be saturated fatty acids, i.e., they contain no carbon-carbon double bonds, or they may be unsaturated fatty acids having, for example, one, two or three sets of carbon-carbon double bonds. One example of a saturated fatty acid having 16 carbon atoms found in some vegetable oils is palmitic acid and one with 18 carbon atoms is stearic acid. Oleic acid is an 18-carbon monounsaturated fatty acid (having one double bond) while linoleic and linolenic acids are 18-carbon polyunsaturated fatty acids (having two and three double bonds respectively) that can be found in some vegetable oils.

Suitable vegetable oils that can be used in the particular embodiments of the present invention include, for example, sunflower oil, soybean oil, safflower oil, corn oil, linseed oil and cotton seed oil. These oils and other such oils may be used singularly or in combination. In some embodiments, sunflower oil having a high oleic acid content is used alone. An example of a sunflower oil having high oleic acid content is AGRI-PURE 80, available from Cargill with offices in Minneapolis, Minn.

In particular embodiments a vegetable oil is selected having an oleic acid content of at least 60 weight percent oleic acid or alternatively, at least 70 weight percent oleic acid or at least 80 weight percent oleic acid. The vegetable oil may be added to the rubber composition in an amount of between 25 phr and 60 phr. Alternatively, particular embodiments include between 25 phr and 50 phr, between 25 and 40 phr, between 25 phr and 30 phr or between 30 phr and 40 phr or between 30 phr and 50 phr of the vegetable oil.

Because of the specific plasticizing system described above, particular embodiments of the rubber composition useful for high performance tire treads as disclosed herein include little or no additional processing oil. Such oils are well known to one having ordinary skill in the art, are generally extracted from petroleum and are classified as being paraffinic, aromatic or naphthenic type processing oil and include, for example, MES and TDAE oils.

Some embodiments of the rubber composition disclosed herein may include an elastomer, such as a styrene-butadiene rubber, that has been extended with one or more such processing oils but such oil is limited in the rubber composition as being no more than 8 phr of the total elastomer content of the rubber composition or alternatively, no more than 6 phr, no more than 3 phr or no more than 1 phr. Likewise other rubber compositions in accordance with the present invention that do not include an extended elastomer may include no more than the same amount of such additional processing oils as might be contained in an extended elastomer as noted above. Other embodiments, of course, include no such additional processing oil.

Particular embodiments of the present invention further include silica as reinforcing filler. The silica may be any reinforcing silica known to one having ordinary skill in the art, in particular any precipitated or pyrogenic silica having a BET surface area and a specific CTAB surface area both of which are less than 450 m²/g or alternatively, between 30 and 400 m²/g. Particular embodiments include a silica having a CTAB of between 80 and 200 m²/g, between 100 and 190 m²/g, between 120 and 190 m²/g or between 140 and 180 m²/g. The CTAB specific surface area is the external surface area determined in accordance with Standard AFNOR-NFT-45007 of November 1987.

Particular embodiments of the rubber compositions used in the tire treads of the passenger and light truck vehicles have a BET surface area of between 60 and 250 m²/g or alternatively, of between 80 and 200 m²/g. The BET specific surface area is determined in known manner, in accordance with the method of Brunauer, Emmet and Teller described in “The Journal of the American Chemical Society”, vol. 60, page 309, February 1938, and corresponding to Standard AFNOR-NFT-45007 (November 1987).

The silica used in particular embodiments may be further characterized as having a dibutylphthlate (DHP) absorption value of between 100 and 300 ml/100 g or alternatively between 150 and 250 ml/100 g.

Highly dispersible precipitated silicas (referred to as “HD”) are used exclusively in particular embodiments of the disclosed rubber composition, wherein “highly dispersible silica” is understood to mean any silica having a substantial ability to disagglomerate and to disperse in an elastomeric matrix. Such determinations may be observed in known manner by electron or optical microscopy on thin sections. Examples of known highly dispersible silicas include, for example, Perkasil KS 430 from Akzo, the silica BV3380 from Degussa, the silicas Zeosil 1165 MP and 1115 MP from Rhodia, the silica Hi-Sil 2000 from PPG and the silicas Zeopol 8741 or 8745 from Huber.

Particular embodiments of the present invention include little or no carbon black or other reinforcement fillers. For those embodiments that include adding a silane coupling agent that is commercially available on a carbon black substrate, up to about 50 wt. % of the commercial coupling agent weight is carbon black. The rubber compositions having such amounts of carbon black may be characterized as having essentially no carbon black. Some embodiments may include up to 10 phr, or up to 5 phr of carbon black just to provide a typical black coloring of the rubber composition.

The amount of silica added to the rubber composition disclosed herein is between 100 phr and 200 phr or alternatively between 105 phr and 200 phr, between 110 phr and 180 phr, between 115 phr and 160 phr, between 120 phr and 150 phr or between 125 phr and 155 phr.

In addition to the silica added to the rubber composition, a proportional amount of a silane coupling agent is also added to the rubber composition. Such coupling agent is added, for example, at between 5% and 10% of the total amount of silica. The silane coupling agent is a sulfur-containing organosilicon compound that reacts with the silanol groups of the silica during mixing and with the elastomers during vulcanization to provide improved properties of the cured rubber composition. A suitable coupling agent is one that is capable of establishing a sufficient chemical and/or physical bond between the inorganic filler and the diene elastomer, which is at least bifunctional, having, for example, the simplified general formula “Y-T-X”, in which: Y represents a functional group (“Y” function) which is capable of bonding physically and/or chemically with the inorganic filler, such a bond being able to be established, for example, between a silicon atom of the coupling agent and the surface hydroxyl (OH) groups of the inorganic filler (for example, surface silanols in the case of silica); X represents a functional group (“X” function) which is capable of bonding physically and/or chemically with the diene elastomer, for example by means of a sulfur atom; T represents a divalent organic group making it possible to link Y and X.

Examples of suitable sulfur-containing organosilicon silane coupling agents include 3,3′-bis(triethoxysilylpropyl)disulfide and 3,3′-bis(triethoxy-silylpropyl) tetrasulfide. Both of these are available commercially from Degussa as X75-S and X50-S respectively, though not in pure form. Both of these commercially available products include the active component mixed 50-50 by weight with a N330 carbon black. Other examples of suitable silane coupling agents include 2,2′-bis(triethoxysilylethyel)tetrasulfide, 3,3′-bis(tri-t-butoxy-silylpropyl)disulfide and 3,3′-bis(di t-butylmethoxysilylpropyl)tetrasulfide. Examples of silane coupling agents having just one silicon atom in the silane molecule include, for example, 3,3′(triethoxysilylpropyl)disulfide and 3,3′ (triethoxy-silylpropyl)tetrasulfide.

The rubber compositions disclosed herein are cured with a sulfur curing system that typically includes sulfur and an accelerator. Suitable free sulfur includes, for example, pulverized sulfur, rubber maker's sulfur, commercial sulfur, and insoluble sulfur. The amount of free sulfur included in the rubber composition may range between 0.5 and 3 phr or alternatively between 0.8 and 2.5 phr or between 1 and 2 phr.

Use may be made of any compound capable of acting as curing accelerator in the presence of sulfur, in particular those chosen from the group consisting of 2-mercaptobenzothiazyl disulphide (MTBS), diphenyl guanidine (DPG), N-cyclohexyl-2-benzothiazolesulphenamide (CBS), N,N-dicyclohexyl-2-benzothiazolesulphenamide (DCBS), N-tert-butyl-2-benzo-thiazole-sulphenamide (TBBS), N-tert-butyl-2-benzothiazolesulphen-imide (TBSI) and the mixtures of these compounds. In particular embodiments, a primary accelerator of the sulphenamide type or guanidine type is used.

Other additives can be added to the rubber composition disclosed herein as known in the art. Such additives may include, for example, some or all of the following: antidegradants, antioxidants, fatty acids, pigments, waxes, stearic acid, zinc oxide and other accelerators. Examples of antidegradants and antioxidants include 6PPD, 77PD, IPPD and TMQ and may be added to rubber compositions in an amount of from 0.5 and 5 phr. Zinc oxide may be added in an amount of between 1 and 6 phr or 2 and 4 phr. Other components that may optionally be added as known to one having ordinary skill in the art include, for example, methylene acceptors, e.g., phenolic novolak resin or methylene donors, e.g., HMT or H3M), vulcanization accelerators, vulcanization activators or anti-reversion agents.

The invention is further illustrated by the following examples, which are to be regarded only as illustrations and not delimitative of the invention in any way. The properties of the compositions disclosed in the examples were evaluated as described below.

Moduli of elongation (MPa) were measured at 10% (MA10), 100% (MA 100) and at 300% (MA300) at a temperature of 23° C. based on ASTM Standard D412 on dumb bell test pieces. The measurement were taken in the second elongation; i.e., after an accommodation cycle. These measurements are secant moduli in MPa, based on the original cross section of the test piece.

Hysteresis losses (HL) were measured in percent by rebound at 60° C. at the sixth impact in accordance with the following equation:

HL(%)=100(W₀−W₁)/W₁,

where W₀ is the energy supplied and W₁ is the energy restored.

The rolling resistance (RR) of a tire is measured on a test drum according to the SAE 1269 test method. The tire is tested on the test drum at 80 kph and 70% of the maximum rated load. A value greater than that of the control, arbitrarily set at 100, indicates an improved result, i.e., a lower rolling resistance.

The dry grip performance (DG) of a tire mounted on an automobile fitted with an ABS braking system is measured by determining the distance necessary to go from 60 mph to a complete stop upon sudden braking on a dry asphalt surface. A value greater than that of the control, which is arbitrarily set to 100, indicates an improved result, i.e., a shorter braking distance and improved dry grip.

The wet braking performance (WB) of a tire mounted on an automobile fitted with an ABS braking system is measured by determining the distance necessary to go from 40 mph to a complete stop upon sudden braking on a wetted (no puddles) asphalt surface. A value greater than that of the control, which is arbitrarily set to 100, indicates an improved result, i.e., a shorter braking distance indicating improved wet grip.

The grip on snow-covered ground is evaluated by measuring the forces on a single driven test tire in snow according to the ASTM F1805 test method. The vehicle travels at a constant 5 mph speed and the forces are measured on the single test tire at the target slip. A value greater than that of the Standard Reference Test Tire (SRTT), which is arbitrarily set to 100, indicates an improved result, i.e., improved grip on snow.

### Example 1

These examples demonstrate the improved rolling resistance and improved dry, wet and snow grip for high performance tires having treads made of the rubber compositions disclosed herein.

Two thermochemical stages were used to prepare the rubber compositions F1 through F4 having the material components shown in Table 1 (amounts shown in phr). First, the elastomers, ⅔ of the silica and all of the other ingredients except for the remaining silica and vulcanization agents were introduced into a 50 liter Banbury-type mixer in the amounts shown in Table 1. After approximately 30 seconds, the remaining ⅓ of the silica was added and the material was mixed until a temperature was reached between 145° C. and 170° C. The mixture was then dropped and cooled to a temperature below 100° C.

In the second thermochemical stage, the cooled mixture was transferred to a mill having two cylinders that operated at a speed of 30 RPM. The vulcanizing agents were added and mixing continued until the vulcanizing agents were well dispersed. The rubber compositions were rolled into sheets and cured for the 30 minutes at a temperature of 150° C. for all the materials.

TABLE 1
Rubber Formulations (phr)

| Formulations | F1 | F2 | F3 | F4 |
|---|---|---|---|---|
| Polybutadiene Rubber (BR) | 36 | 36 | 36 | 36 |
| Styrene-Butadiene Rubber (SBR) | 64 | 64 | 64 | 64 |
| MES Oil* | 6.4 | 6.4 | 6.4 | 6.4 |
| Silica | 130 | 130 | 130 | 130 |
| Sunflower Oil | 36 | 43 | 31 | 26 |
| High Tg Resin | 30 | 20 | 27 | 25 |
| Silane Coupling Agent (SI69) ^{†} | 9.75 | 9.75 | 9.75 | 9.75 |
| Carbon Black | 10 | 10 | 10 | 10 |
| Paraffin | 1.5 | 1.5 | 1.5 | 1.5 |
| Zinc Oxide | 1.5 | 1.5 | 1.5 | 1.5 |
| Sulfur | 1.2 | 1.2 | 1.2 | 1.2 |
| Accelerators | 4.44 | 4.44 | 4.44 | 4.44 |
| Stearic Acid | 2.5 | 2.5 | 2.5 | 2.5 |
| Antidegradants | 2.0 | 2.0 | 2.0 | 2.0 |

*MES oil was an extender oil for the SBR
^{†} 3,3′-bis(triethoxy-silylpropyl) tetrasulfide

The SBR was an oil extended rubber and the oil portion, i.e., 6.4 MES oil, is broken out separately in Table 1 above. No additional plasticizing oil was added to the composition. The SBR had a styrene content of 25% by weight and the vinyl content of the butadiene part was 60%. The Tg of the SBR was −26° C. The BR had 98 wt. % cis 1,4-content and a Tg of −108° C.

Carbon black was added only to give a black color to the composition and was in the N200 series of blacks. The sunflower oil was AGRI-PURE 80, a high oleic acid sunflower oil available from Cargill Industries.

The high Tg resin was Sylvares TR 5147 from Arizona Chemical, a terpene resin having a Tg of 72° C. The silica was a ZEOSIL 160, highly dispersible silica available from Rhodia. The accelerators were n-cyclohexyl-2-benzothiazole sulfenamide (CBS) and diphenylguanidine (DPG).

The cured sheets were of the rubber formulations F1 through F4 were cut into testing pieces suitable for the testing methods utilized to determine the physical characteristics of the examples. The witness material (W2) was a tread compound used for manufacturing the treads of the PRIMACY MXM4 tire marketed by Michelin with a V speed rating. The physical properties of these materials are shown in Table 2.

TABLE 2
Physical Properties of Rubber Formulations

| Physical Properties | W2 | F1 | F2 | F3 | F4 |
|---|---|---|---|---|---|
| MA10, MPa | 5.88 | 6.65 | 6.04 | 6.72 | 7.03 |
| MA100, MPa | 1.71 | 1.62 | 1.72 | 1.84 | 2.44 |
| MA300, MPa | 1.71 | 1.48 | 1.44 | 1.51 | 2.55 |
| Hysteresis Loss (%) | 35.5 | 39.8 | 42.3 | 43.5 | 37.5 |

Tires were manufactured (245/40 ZR18 93Y TL PILOT SPORT A/S 2) using the formulations shown above to form the treads. They were tested using the testing procedures described above. The tires were mounted on a BMW M3 car. The results were normalized against the results obtained from testing of the Pilot Sport A/S+ high performance tire marketed by Michelin.

TABLE 3
Tire Results

| Tire Tests | W1 | W2 | F1 | F2 | F3 | F4 |
|---|---|---|---|---|---|---|
| Rolling Resistance (Index) | 100 | 131 | 127 | 120 | 118 | 119 |
| Wet Grip (Index) | 100 | 97.5 | 110 | 107 | 109 | 104 |
| Dry Grip (Index) | 100 | 104 | 108 | 104 | 104 | 103 |
| Snow Grip (Index) | 100 | 113 | 110 | 130 | 110 | 104 |

The test results show that with treads made of the rubber compositions that are particular embodiments of the present invention, the tires surprisingly demonstrated a significant increase in rolling resistance performance as well as improved wet, dry and snow grip.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

1. A tire, the tire comprising a tread constructed of a material that is based upon a cross-linkable rubber composition, the cross-linkable rubber composition comprising, per 100 parts by weight of rubber (phr):
between 25 phr and 50 phr of a butadiene rubber;
between 50 phr and 75 phr of a styrene-butadiene rubber (SBR), wherein a butadiene portion of the SBR has at least 50% vinyl content;
25 phr and 60 phr of a plasticizing resin having a glass transition temperature Tg of between 30° C. and 120° C.;
between 25 phr 60 phr of a vegetable oil; and
between 100 phr and 200 phr of a silica filler.

2. The tire of claim 1, wherein the butadiene portion of the SBR has between 55% and 65% vinyl content.

3. The tire of claim 1, wherein the rubber composition comprises between 30 phr and 45 phr of the butadiene rubber and between 55 phr and 70 phr of the SBR.

4. The tire of claim 3, wherein the butadiene portion of the SBR has between 55% and 65% vinyl content.

5. The tire of claim 1, wherein the resin has a number average molecular weight of between 400 and 2000 g/mol and a polydispersity index of less than 3.

6. The tire of claim 1, wherein the resin has a Tg of between 45° C. and 85° C.

7. The tire of claim 1, wherein the resin is a polylimonene.

8. The tire of claim 1, wherein the rubber composition comprises between 110 phr and 180 phr of a highly dispersible precipitated silica.

9. The tire of claim 1, wherein a ratio of the vegetable oil phr to the high Tg resin phr is between 0.75 and 3.

10. The tire of claim 9, wherein the ratio is between 1.1 and 2.5.

11. The tire of claim 1, wherein the plasticizing resin is a hydrocarbon resin.

12. The tire of claim 1, wherein the butadiene rubber is a functionalized elastomer.

13. The tire of claim 1, wherein the styrene-butadiene rubber is a functionalized elastomer.

14. The tire of claim 13, wherein the styrene-butadiene rubber is a silanol end-functionalized elastomer.

15. The tire of claim 1, wherein the SBR has a glass transition temperature of between −35° C. and −20° C.
